(19) United States
(12) Patent Application Publication
(10) Pub. No.: US 2017/0361823 A1
(43) Pub. Date: Dec. 21, 2017

(54) ELECTRIC BRAKE APPARATUS AND CONTROL METHOD THEREOF

(71) Applicant: MANDO CORPORATION, Pyeongtaek-si (KR)

(72) Inventor: Hyun Ho KIM, Yongin-si (KR)

(21) Appl. No.: 15/187,406

(22) Filed: Jun. 20, 2016

(51) Int. Cl. B60T 13/68; B60T 8/1755; B60T 13/16; B60T 8/34; B60T 13/58

(52) U.S. Cl. CPC B60T 13/686; B60T 13/161; B60T 8/34; B60T 8/1755; B60T 13/58; B60T 2270/304

(57) ABSTRACT

An electric brake apparatus of the present invention relates to an electronic brake apparatus that includes a pump unit driven based on driving of a motor and a plurality of wheel cylinders each of which receives a fluid pressure generated by the pump unit. The electric brake apparatus includes: a hydraulic circuit disposed between the pump unit and the wheel cylinders; a plurality of wheel valves that regulate a fluid flow between the hydraulic circuit and the wheel cylinders; and an electronic control unit that controls the wheel valves and the motor, wherein the electronic control unit controls the wheel valves and the motor on the basis of an input of a driver's pedaling of a brake pedal and a need for electronic stability control.

### BACKGROUND

### 1. Field of the Invention

The present invention is related to an electric brake system of a vehicle and a control method using the same, and more particularly, to an electric brake apparatus capable of reflecting driver's braking intent even when braking power is generated by electronic stability control (ESC) and a control method using the same.

### 2. Discussion of Related Art

Recently, vehicle technologies have been advancing according to increasing customer demand for eco-friendly technologies. In addition, various electric devices are included in the vehicle.

Particularly, to further improve driver safety, electronic stability control (ESC) systems are widely included in recent vehicles. The ESC system is an apparatus that electronically controls a brake included in each wheel to stably control a vehicle stance.

However, in a vehicle, there is a problem in that using a conventional brake system utilizing a vacuum booster is difficult since the use of an engine is limited. Accordingly, an integrated electric booster is used, however, individually controlling two hydraulic circuits therein is theoretically impossible using one fluid pressure source included therein.

Accordingly, there is a problem in that a driver feels a strange sensation.

Thus, a method to resolve the above-describe problems are being demanded.

### Patent Document

Korean Patent Registration No. 10-0844670

### SUMMARY OF THE INVENTION

The present invention is directed to providing a brake control system of a vehicle and a control method using the same for reflecting a driver's intension during a simultaneous occurrence of braking intended by a driver and braking under an electronic stability control (ESC) in an integrated electric booster in which an electric booster is integrated with an ESC system.

The present invention is also directed to minimizing a strange sensation during driver's driving.

The scope of the present invention is not limited to the above-described objects, and other unmentioned objects may be clearly understood by those skilled in the art from the following descriptions.

According to an aspect of the present invention, there is provided an electric brake apparatus that includes a pump unit driven based on driving of a motor and a plurality of wheel cylinders, each of which receives a fluid pressure generated by the pump unit. The electric brake apparatus includes: a hydraulic circuit disposed between the pump unit and the wheel cylinders; a plurality of wheel valves that regulate a fluid flow between the hydraulic circuit and the wheel cylinders; and an electronic control unit that controls the wheel valves and the motor, wherein the electronic control unit controls the wheel valves and the motor on the basis of an input of a driver stepping on a brake pedal and a need for ESC.

The electronic control unit may include: a braking determination device that determines a driver's braking intent on the basis of an output value of a stroke sensor that detects the driver's pedal operation; an ESC device that determines a need for the electric stability control of a vehicle on the basis of an output of at least one sensor installed in the vehicle; a motor controller that controls the motor on the basis of an output of at least one of the braking determination device and the ESC device; and a wheel valve controller that controls the wheel valves on the basis of an output of at least one of the braking determination device and the ESC device.

The hydraulic circuit may include a first hydraulic circuit that connects the pump unit to some of the wheel cylinders and the second hydraulic circuit that connects the pump unit to the other wheel cylinders, and the electronic control unit may control to open the wheel valves of the wheel cylinders connected to the second hydraulic circuit when an input of a driver stepping on a brake pedal is detected while supplying a fluid to the wheel cylinders connected to the first hydraulic circuit for the ESC of the vehicle.

The hydraulic circuit may include a first hydraulic circuit that connects the pump unit to some of the wheel cylinders and the second hydraulic circuit that connects the pump unit to the other wheel cylinders, and the electronic control unit may control to open the wheel valves of the wheel cylinders connected to the second hydraulic circuit when electronic stability control is needed while supplying a fluid to the wheel cylinders connected to the first hydraulic circuit to brake a vehicle when an input of a driver stepping on a brake pedal is detected.

According to another aspect of the present invention, there is provided a control method of an electric brake apparatus that includes a pump unit driven based on driving of a motor and a plurality of wheel cylinders each of which receives a fluid pressure generated by the pump unit. The control method includes: detecting one of an input of a user braking and a need for ESC of a vehicle; driving the motor and discharging a fluid into a hydraulic circuit disposed between the pump unit and the wheel cylinders by an electronic control unit; controlling a plurality of wheel valves disposed between the hydraulic circuit and the wheel cylinders by the electronic control unit; and generating braking power for one of the plurality of wheels on the basis of the controlling of the plurality of wheel valves.

The hydraulic circuit may include a first hydraulic circuit that connects the pump unit to some of the wheel cylinders and the second hydraulic circuit that connects the pump unit to the other wheel cylinders, and the electronic control unit may control to open the wheel valves of the wheel cylinders connected to the second hydraulic circuit when an input of a driver stepping on a brake pedal is detected while supplying a fluid to the wheel cylinders connected to the first hydraulic circuit for the ESC of the vehicle.

The hydraulic circuit may include a first hydraulic circuit that connects between the pump unit and some of the wheel cylinders and the second hydraulic circuit that connects between the pump unit and the other wheel cylinders, and the electronic control unit may control to open the wheel valves of the wheel cylinders connected to the second hydraulic circuit when electronic stability control is needed while supplying a fluid is supplied to the wheel cylinders connected to the first hydraulic circuit to brake a vehicle when an input of a driver stepping on a brake pedal is detected.

The detecting of the input of braking may include detecting a driver's braking intent by a stroke sensor that detects a driver's pedal operation.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating each component of an electric bake apparatus according to one embodiment of the present invention;

FIG. 2 is a graph that shows a wheel pressure while a vehicle is moving under an electronic stability control (ESC) and a wheel pressure reflecting driver's braking;

FIG. 3 is a view specifically illustrating an electronic control unit (ECU) in the electric brake apparatus according to one embodiment of the present invention;

FIG. 4 is a flowchart illustrating each operation of the control method of the electric brake apparatus according to one embodiment of the present invention;

FIG. 5 is a flowchart illustrating an algorithm of the control method of a brake of a vehicle according to one embodiment of the present invention; and

FIG. 6 is a flowchart illustrating another algorithm of a control method of the brake of the vehicle according to one embodiment of the present invention.

### DETAILED DESCRIPTION OF EXEMPLARY EMBODIMENTS

Hereinafter, exemplary embodiments of the present invention will be described in detail with reference to the accompanying drawings. In describing the embodiments, the same names and reference numerals refer to the same components, and repeated descriptions thereof will be omitted accordingly.

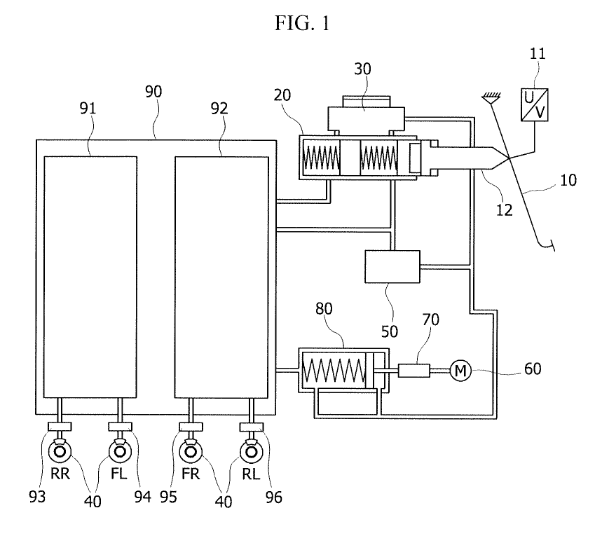

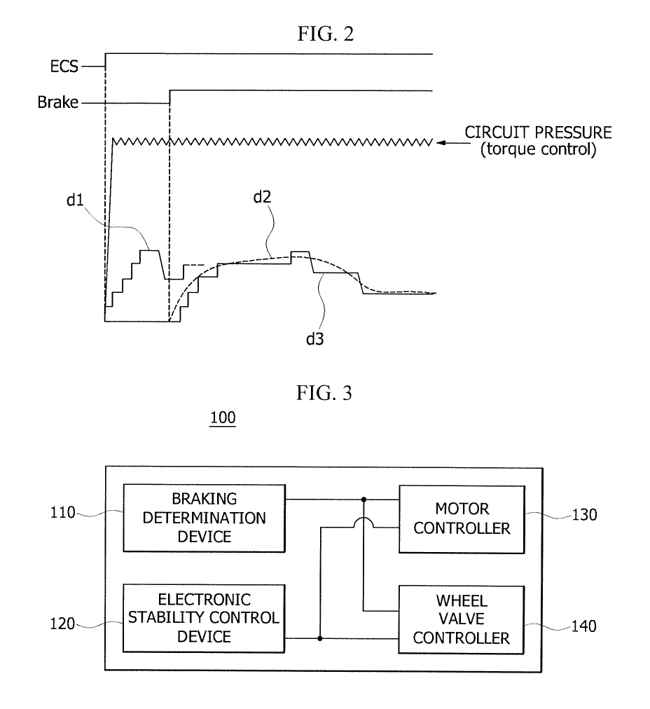

FIG. 1 is a view illustrating each component of an electric bake apparatus according to one embodiment of the present invention, FIG. 2 is a graph that shows a wheel pressure while a vehicle is moving under an electronic stability control (ESC) and a wheel pressure reflecting driver's braking, and FIG. 3 is a view specifically illustrating an electronic control unit (ECU) in the electric brake apparatus according to one embodiment of the present invention.

As illustrated in FIG. 1, an electric brake apparatus includes a master cylinder 20, a reservoir 30, wheel cylinders 40, a pedal simulator 50, a motor 60, a gear unit 70, and a pump unit 80.

The master cylinder 20 is pressurized by an input rod 12 when a driver operates a brake pedal 10 and performs a function of generating a fluid pressure, the generated fluid pressure is transmitted to the pedal simulator 50, the pedal simulator 50 transmits a reaction force via the master cylinder 20 corresponding to the fluid pressure to the brake pedal 10, and thus the driver feels a pedaling sensation. In addition, in an emergency situation such as when no power is supplied to the entire system, the vehicle may also be braked due to a direct transmission of the fluid pressure of the master cylinder 20 to the wheel cylinders 40.

Meanwhile, in a normal situation, the pump unit 80 transmits a fluid to the wheel cylinders 40. Specifically, when a driver presses the brake pedal 10 to cause a stroke sensor 11 to detect a displacement of the brake pedal 10 and transmit the displacement to the ECU, the ECU drives the motor 60 on the basis of the displacement of the brake pedal 10. When a rotary motion generated by the motor 60 is converted into a straight-line reciprocating motion by the gear unit 70 to press a piston in the pump unit 80, a fluid accommodated in a chamber of the pump unit 80 is moved to the wheel cylinders 40.

The reservoir 30 is a unit for storing a fluid and is configured to communicate with the master cylinder 20, the pedal simulator 50, and the pump unit 80 through the fluid. In addition, a hydraulic circuit 90 includes a flow path for transferring a fluid between the pump unit 80 and the wheel cylinders 40 and valves for regulating a fluid flow in the flow path.

Such a hydraulic circuit 90 may be divided into a first hydraulic circuit 91 and a second hydraulic circuit 92. Specifically, the first hydraulic circuit 91 is a circuit that connects the pump unit 80 to a part of the wheel cylinders 40, and the second hydraulic circuit 92 is a hydraulic circuit that connects the remaining pump unit 80 to the remaining part of the wheel cylinders 40. For example, as illustrated in FIG. 1, a wheel cylinder 40 of rear right (RR) and front left (FL) wheels and the pump unit 80 are connected by the first hydraulic circuit 91, and a wheel cylinder 40 of front right (FR) and rear left (RL) wheels are connected by the second hydraulic circuit 92.

Meanwhile, a plurality of wheel valves 93, 94, 95, and 96 that regulate fluid flowing between the hydraulic circuit 90 and the wheel cylinders 40 are disposed between the hydraulic circuit 90 and the wheel cylinders 40. As illustrated in FIG. 1, the first wheel valve 93 may be disposed between the first hydraulic circuit 91 and the wheel cylinder of the RR wheel, the second wheel valve 94 may be disposed between the first hydraulic circuit 91 and the wheel cylinder of the FL wheel, the third wheel valve 95 may be disposed between the second hydraulic circuit 92 and the wheel cylinder of the FR wheel, and the fourth wheel valve 96 may be disposed between the second hydraulic circuit 92 and the wheel cylinder of the RL wheel.

An ECU 100 is a unit that performs a function of controlling driving of the motor 60 or opening and closing of the wheel valves. The ECU 100 in the electric brake apparatus according to one embodiment of the present invention controls the wheel valves and motor 60 on the basis of an input of a driver stepping on a brake pedal and a need for an ESC.

For example, as illustrated in FIG. 2, when the ECU 100 determines that the ESC is needed while a vehicle is moving, the ECU 100 first drives the motor 60 to fill the hydraulic circuit 90 with a fluid, and a pressure in the hydraulic circuit 90 is thus increased.

Since a current state is a state in which the ESC is being performed, a power piston generates a high pressure in the hydraulic circuit as indicated by d1 in the graph shown in FIG. 2, and the target wheel is controlled.

When driver braking is input in such a state, the ECU 100 determines driver's intent to brake and calculates braking power of the driver braking as indicated by d2 in the graph. Then the ECU 100 opens the wheel valves that were closed by the ESC to generate a fluid pressure as indicated by d3 in the graph, and accordingly controls the wheels according to the calculated driver braking power.

Accordingly, according to one embodiment of the present invention, when braking intended by a driver and control of an ESC apparatus simultaneously occur, there are advantages in that the driver's braking intent and turning intent may be reflected and a driver's sense of strangeness may be minimized.

To realize the above-described technological effects, as illustrated in FIG. 3, the ECU 100 may specifically include a braking determination device 110, an ESC device 120, a motor controller 130, and a wheel valve controller 140.

The braking determination device 110 performs a function for determining the driver's intent on the basis of an output value of the stroke sensor 11 that detects a driver's pedal operation.

The ESC device 120 performs a function for determining a need for the ESC of the vehicle on the basis of an output from at least one sensor, for example, a lateral acceleration sensor, an acceleration sensor, a yaw rate sensor, etc., installed in the vehicle.

The motor controller 130 performs a function for controlling the motor 60 on the basis of one output of at least one of the braking determination device 110 and the ESC device 120.

The wheel valve controller 140 controls the wheel valves on the basis of an output of at least one of the braking determination device 110 and the ESC device 120.

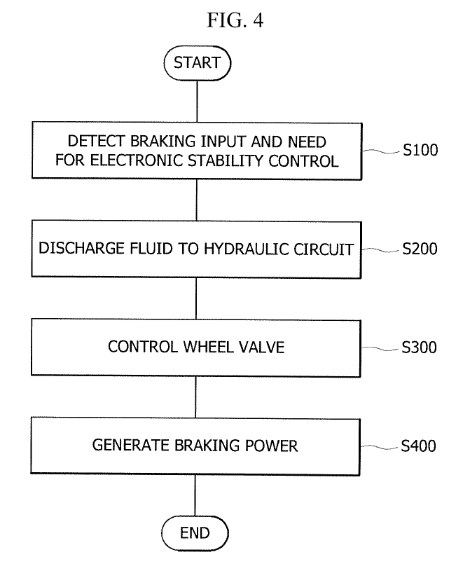

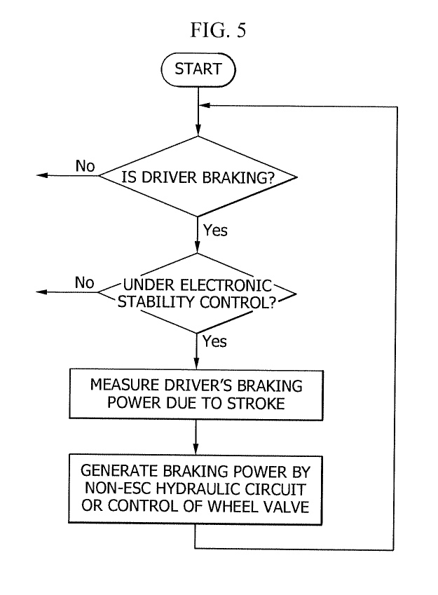

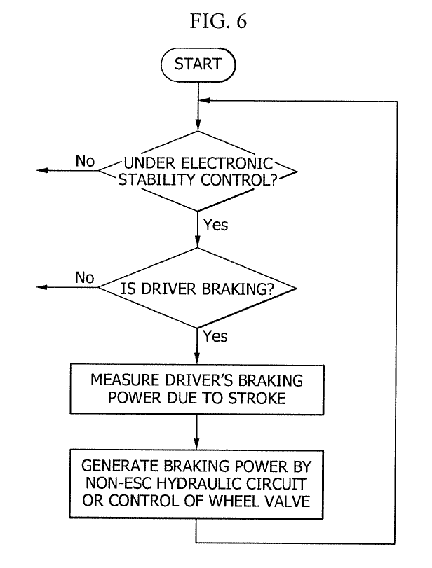

Hereinafter, a control method of the electric brake apparatus according to one embodiment of the present invention will be described with reference to FIGS. 4 to 6. However, detail descriptions that are overlapped with the descriptions already described for the electric brake apparatus according to one embodiment of the present invention will be omitted. FIG. 4 is a flowchart illustrating each operation of the control method of the electric brake apparatus according to one embodiment of the present invention, FIG. 5 is a flowchart illustrating an algorithm of the control method of a brake of a vehicle according to one embodiment of the present invention, and FIG. 6 is a flow chart illustrating another algorithm of a control method of the brake of the vehicle according to one embodiment of the present invention.

A control method of the electric brake apparatus according to one embodiment of the present invention is related to controlling the pump unit driven based on driving of the motor and a plurality of wheel cylinders that receives a fluid pressure generated by the pump unit.

The control method of the electric brake apparatus according to one embodiment of the present invention is mainly divided into four operations as illustrated in FIG. 4.

First, a detection for at least one of an input of a user braking and a need for an ESC of a vehicle is performed (S100).

After operation S100 is performed, discharging a fluid to the hydraulic circuit disposed between the pump unit and the wheel cylinder by driving the motor is performed by the ECU (S200).

Then, controlling the plurality of wheel valves disposed between the hydraulic circuit and the wheel cylinder is performed by the ECU (S300), and generating braking power for at least one of the plurality of wheels on the basis of the control of the wheel valves (S400) is performed.

Meanwhile, a case in which the ESC is performed while a user is braking or, conversely, driver's braking intent is detected while the ESC is being performed will be specifically described with reference to FIGS. 5 and 6.

First, as illustrated in FIG. 5, when the ESC is needed while a driver is braking, target braking power is measured by the stroke sensor, and required braking power may be independently applied to each wheel by a non-ESC hydraulic circuit or by the control of the wheel valve based on the target braking power.

In addition, as illustrated in FIG. 6, when an input of a driver stepping on a brake pedal is detected under ESC, target braking power is measured by the stroke sensor, and required braking power may be independently applied to each wheel by a non-ESC hydraulic circuit or by the control of the wheel valve based on the target braking power.

As described above, a brake control system of a vehicle and a control method using the same according to one embodiment of the present invention have effects as follows.

First, there is an advantage of being able to reflect a driver's braking and turning intent when braking intended by a driver and ESC simultaneously occur.

Second, there is also an advantage of minimizing a strange feeling sensed by a driver while a driver drives a vehicle.

Effects of the present invention is not limited to the above-described effects, and other unmentioned effects may be clearly understood by those skilled in the art from the above descriptions.

The embodiments and drawings described in the specification are only examples for describing a part of a technological concept included in the present invention. Accordingly, since the embodiments disclosed in this specification are not for limiting the concept of the present invention but are for describing the concept, it is clear that the scope of the concept of the invention is not limited by the embodiments. All modifications and specific embodiments that may be easily made by those skilled in the art within the technical concept included in the specification and the drawings in the present invention fall within the scope of the appended claims.

What is claimed is:

1. An electric brake apparatus that includes a pump unit driven based on driving of a motor and a plurality of wheel cylinders, each of which receives a fluid pressure generated by the pump unit, the electric brake apparatus comprising:
a hydraulic circuit disposed between the pump unit and the wheel cylinders;
a plurality of wheel valves that regulate a fluid flow between the hydraulic circuit and the wheel cylinders; and
an electronic control unit that controls the wheel valves and the motor,
wherein the electronic control unit controls the wheel valves and the motor on the basis of an input of a driver stepping on a brake pedal and a need for electronic stability control.

2. The electric brake apparatus of claim 1, wherein the electronic control unit includes:
a braking determination device that determines a driver's braking intent on the basis of an output value of a stroke sensor that detects the driver's pedal operation;
an electronic stability control device that determines a need for the electric stability control of a vehicle on the basis of an output of at least one sensor installed in the vehicle;
a motor controller that controls the motor on the basis of an output of at least one of the braking determination device and the electronic stability control device; and
a wheel valve controller that controls the wheel valves on the basis of an output of at least one of the braking determination device and the electronic stability control device.

3. The electric brake apparatus of claim 1, wherein:
the hydraulic circuit includes a first hydraulic circuit that connects the pump unit to some of the wheel cylinders and a second hydraulic circuit that connects the pump unit to the other wheel cylinders; and
the electronic control unit controls to open the wheel valves of the wheel cylinders connected to the second hydraulic circuit when an input of a driver stepping on a brake pedal is detected while supplying a fluid to the wheel cylinders connected to the first hydraulic circuit for the electronic stability control of the vehicle.

4. The electric brake apparatus of claim 1, wherein:
the hydraulic circuit includes a first hydraulic circuit that connects the pump unit to some of the wheel cylinders and a second hydraulic circuit that connects the pump unit to the other wheel cylinders; and
the electronic control unit controls to open the wheel valves of the wheel cylinders connected to the second hydraulic circuit when electronic stability control is needed while supplying a fluid to the wheel cylinders connected to the first hydraulic circuit to brake a vehicle when an input of a driver stepping on a brake pedal is detected.

5. A control method of an electric brake apparatus that includes a pump unit driven based on driving of a motor and a plurality of wheel cylinders, each of which receives a fluid pressure generated by the pump unit, the control method comprising:
detecting one of an input of a user braking and a need for electronic stability control of a vehicle;
driving the motor and discharging a fluid into a hydraulic circuit disposed between the pump unit and the wheel cylinders by an electronic control unit;
controlling a plurality of wheel valves disposed between the hydraulic circuit and the wheel cylinders by the electronic control unit; and
generating braking power for one of a plurality of wheels on the basis of the controlling of the plurality of wheel valves.

6. The control method of claim 5, wherein:
the hydraulic circuit includes a first hydraulic circuit that connects the pump unit to some of the wheel cylinders and a second hydraulic circuit that connects the pump unit to the other wheel cylinders; and
the electronic control unit controls to open the wheel valves of the wheel cylinders connected to the second hydraulic circuit when an input of a driver stepping on a brake pedal is detected while supplying a fluid to the wheel cylinders connected to the first hydraulic circuit for the electronic stability control of the vehicle.

7. The control method of claim 5, wherein:
the hydraulic circuit includes a first hydraulic circuit that connects between the pump unit and some of the wheel cylinders and a second hydraulic circuit that connects between the pump unit and the other wheel cylinders; and
the electronic control unit controls to open the wheel valves of the wheel cylinders connected to the second hydraulic circuit when electronic stability control is needed while supplying a fluid to the wheel cylinders connected to the first hydraulic circuit to brake a vehicle when an input of a driver stepping on a brake pedal is detected.

8. The control method of claim 5, wherein the detecting of the input of braking includes detecting a driver's braking intent by a stroke sensor that detects a driver's pedal operation.
